(19) United States
(12) Patent Application Publication
(10) Pub. No.: US 2025/0319703 A1
(43) Pub. Date: Oct. 16, 2025

(54) SYSTEMS AND METHODS FOR PREDICTING PRINTER COMPONENT FAILURE

(71) Applicant: Videojet Technologies Inc., Wood Dale, IL (US)

(72) Inventors: Fredinand SUSI, Wood Dale, IL (US); Robert WEAVER, Sandy Springs, GA (US); Ramasamy KANNAN, Bangalore (IN); Duc NGUYEN, Brampton (GB)

(73) Assignee: Videojet Technologies Inc., Wood Dale, IL (US)

(21) Appl. No.: 19/251,178

(22) Filed: Jun. 26, 2025

Related U.S. Application Data
(63) Continuation of application No. PCT/US2023/085685, filed on Dec. 22, 2023.
(60) Provisional application No. 63/435,424, filed on Dec. 27, 2022.

(51) Int. Cl. B41J 2/175; B41J 29/393; B41J 29/46; G06F 3/12

(52) U.S. Cl. CPC B41J 2/17596; B41J 29/393; B41J 29/46; G06F 3/121; G06F 3/1234

(57) ABSTRACT

Systems and methods for predicting pump failures are disclosed. A method includes: receiving, by one or more processing circuits, speed data indicative of a pump speed over a time period, the speed data associated with a pump of a printer; receiving, by the one or more processing circuits, pressure data indicative of a pump pressure over the time period, the pressure data associated with the pump; identifying, by the one or more processing circuits, a change in pump speed and a corresponding decrease in pump pressure exceeding an allowable pump pressure decrease threshold for the time period; and, initiating, by the one or more processing circuits, a response action based on the identification of the change in pump speed and the corresponding decrease in pump pressure exceeding an allowable pump pressure decrease threshold for the time period.

### CROSS-REFERENCE TO RELATED APPLICATIONS

This application is a continuation of PCT/US2023/085685, filed Dec. 22, 2023, which claims priority to and the benefit of U.S. Provisional Patent Application No. 63/435,424, filed Dec. 27, 2022, all of which are incorporated herein by reference in their entireties.

### TECHNICAL FIELD

Embodiments of the present disclosure relate generally to systems and methods for monitoring and controlling printer components to predict failure of one or more of the components and to troubleshoot one or more of the components.

### BACKGROUND

Printers can provide various operations, such as printing, scanning, copying, and other operations useful in residential or commercial environments. However, it is difficult to predict when a component will fail and it often takes a long time to replace the component, leaving the printer unusable, at least for some operations, which can be disruptive and result in significant time and/or cost losses. For example, an ink pump of a printer may fail and render the printer incapable of printing. The ability for a technician or someone capable of replacing the failed component to travel to the location of the printer and replace the component may take several days or weeks. Enhanced systems and methods for predicting component failure and reducing or eliminating downtime during which a printer is not functional are desirable.

### SUMMARY

A first exemplary embodiment relates to a method for predicting pump failure. The method includes receiving, by one or more processing circuits, speed data indicative of a pump speed over a time period. The speed data is associated with a pump of a printer. The method includes receiving, by the one or more processing circuits, pressure data indicative of a pump pressure over the time period. The pressure data is associated with the pump. The method includes: identifying, by the one or more processing circuits, a change in pump speed and a corresponding decrease in pump pressure exceeding an allowable pump pressure decrease threshold for the time period; and initiating, by the one or more processing circuits, a response action based on the identification of the change in pump speed and the corresponding decrease in pump pressure exceeding an allowable pump pressure decrease threshold for the time period.

Another exemplary embodiment relates to a printer system. The printer system includes a pump and at least one processing circuit coupled to the pump. The at least one processing circuit is configured to: determine that the pump is on; track a speed of the pump while the pump is on; track a pressure of the pump corresponding to the tracked speed while the pump is on; provide the tracked speed and the tracked pressure to a remote computing system; and initiate a diagnostic action based on the tracked speed and the tracked pressure indicating a decrease in pump pressure exceeds an allowable pump pressure decrease threshold for a predefined time period of operation of the pump.

Still another exemplary embodiment relates to a computing system. The computing system includes at least one memory device storing instructions therein and at least one processor coupled to the at least one memory device. The at least one processor is structured to execute the instructions stored in the at least one memory device to perform operations. The operations include: receiving operational data for a plurality of networked printers, the operational data comprises speed data and pressure data for a printer component; determining a threshold associated with the printer component based on the operational data for the plurality of networked printers; receiving operational data for a specific printer of the plurality of networked printers over a time period; identifying a change in speed and a corresponding decrease in pressure exceeding the threshold for the time period for a printer component of the specific printer; and initiating a response action based on the identification of the change in speed and the corresponding decrease in pressure exceeding the threshold for the time period.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a component status identification computing system, according to some embodiments.

FIG. 2A is a schematic diagram of a printer, according to some embodiments.

FIG. 2B is a schematic diagram of a component status identification computing system, according to some embodiments.

FIG. 3 is a schematic diagram of a provider computing system of the system of FIG. 1, according to some embodiments.

FIG. 4 is a flow chart of a process for predicting printer component and, particularly, pump failure, according to some embodiments.

FIG. 5 is a flow chart of a process for predicting printer component and, particularly, pump failure, according to some embodiments.

FIG. 6 is an illustration of a user interface with a failure notification, according to some embodiments.

FIG. 7 is a graph of pump speed data and pump pressure data, according to some embodiments.

FIG. 8 is a graph of pump speed data, according to some embodiments.

FIG. 9 is a flow diagram of a process for predicting printer component, and particularly, pump failure, according to some embodiments.

### DETAILED DESCRIPTION

Referring to the figures generally, aspects and embodiments of the present disclosure relate to a printer component failure prediction system that tracks performance data of a printer system and predicts component failure based on the performance data. More specifically, the present disclosure relates to a printer pump failure prediction system that monitors pump speed and pump pressure to predict when a pump of a printer is likely to fail. In one embodiment, the system can compare pump speed data and pressure data to thresholds indicative of pump failure, update the thresholds based on other data and/or other characteristics of the pump and/or printer, and initiate a response action based on the detection of an impending pump failure.

The systems and methods disclosed herein provide the technical advantage of monitoring a status (e.g., health, etc.) of a printer from a remote location, predicting when a component of the printer is likely to fail by analyzing various information in real-time or near real-time, and alerting the appropriate personnel with the appropriate information when failure is impending. The disclosed solution can limit the data analyzed when determining a status of a component by only analyzing data that exceeds a threshold. Limiting the data that is analyzed can reduce the computational load on the computing system and facilitate quicker analyses to provide real-time or near real-time diagnostics. The disclosed solution also provides the technical advantage of analyzing various printer characteristics and printer data for a plurality of printers such that predetermined thresholds that indicate impending failure of a component may be updated remotely based on the new and dynamically changing information that the system receives or detects.

According to the present disclosure, a printer component failure prediction system can track speed data and pressure data associated with a pump of a printer over a period of operation of the printer, such as a period of time. The system can identify a change in speed and a change in pressure based on the tracked data and compare the changes to one or more predetermined thresholds. The one or more predetermined thresholds can be values that are indicative of pump failure. For example, a threshold can be a percentage increase in pump speed or a maximum pump speed. When at least one of the pump speed or the pump pressure exceeds the predetermined threshold, the system may initiate various responses to either confirm the status of the pump or to notify appropriate personnel (e.g., user, technician, provider, etc.) of the status of the pump. For example, the system may provide a notification indicative of the status of the pump such that the pump can be replaced prior to failing and causing printer down-time. As another example, the system can cause the printer to perform a print cycle and monitor the performance of the printer during the print cycle to verify that the pump is close to failure or not close to failure. The system can update the one or more thresholds periodically based on various factors, including but not limited to a number of print cycles performed, an age of the pump, environmental factors associated with the printer environment (e.g., humidity), etc. In this way, the one or more thresholds may be tailored for various specific circumstances. These and other features and benefits are described more fully herein below.

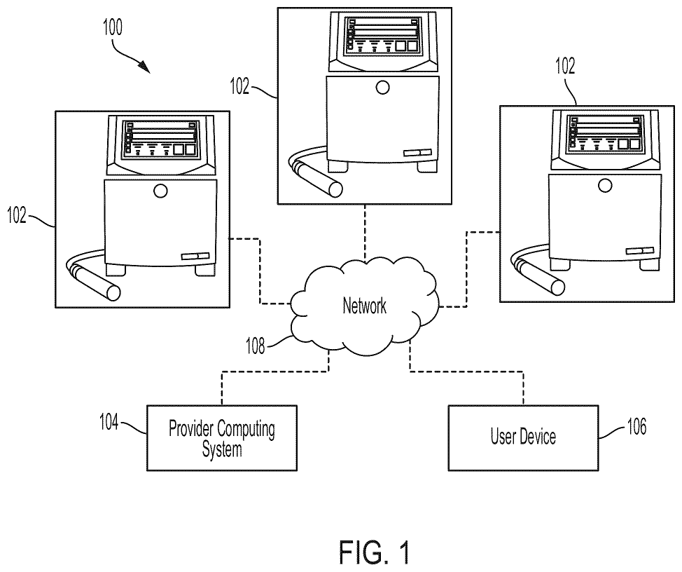

Referring now to FIG. 1, a system 100 for predicting and servicing printer component(s) failure is shown (also referred to as a component failure prediction system), according to some embodiments. As shown in FIG. 1, the system 100 includes at least one printer or printer system, shown as printer 102, a provider computing system 104 associated with a provider, and a user device 106 communicable via a network 108. In the example shown, the network 108 is a wireless network. In some embodiments, the system 100 may include a plurality of printers 102. The printers 102 may be at the same location or at different locations. For example, a first plurality of printers may be deployed at one industrial location while a second plurality of printers are deployed at a second industrial location. The network 108 can be or include the Internet, an intranet, a cellular network, a Wi-Fi network, etc. In other embodiments, a wired network may be used. In still other embodiments, a combination of wired and/or wireless networks may be utilized. In the example depicted, the provider computing system 104 is physically remote from the printer 102 and the user device 106.

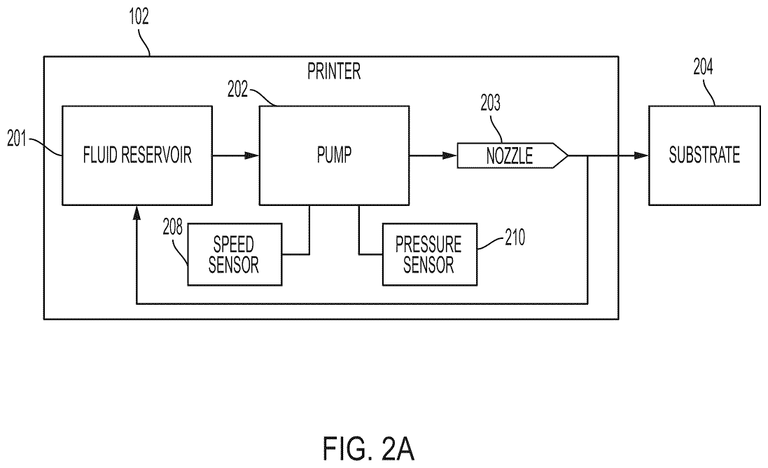

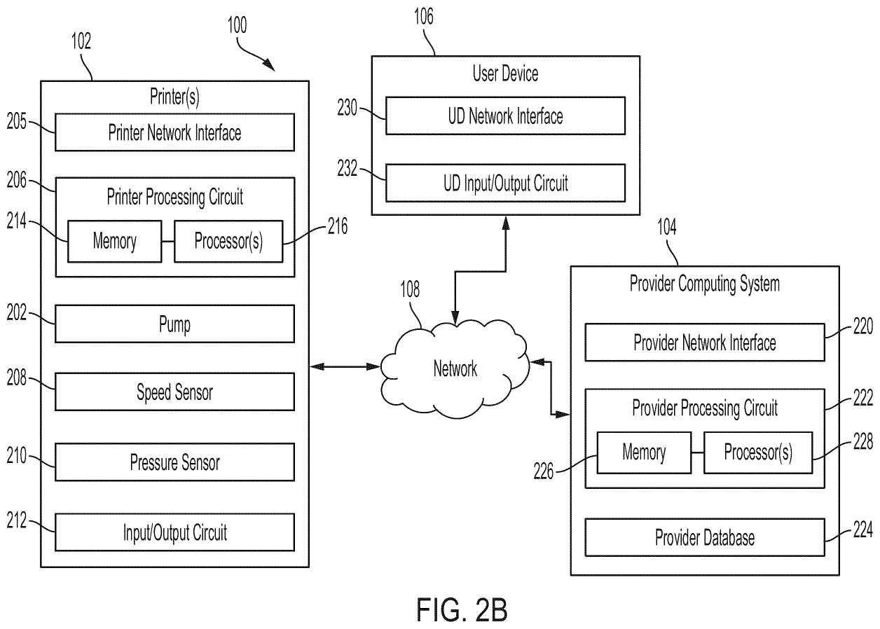

Referring to FIG. 2A, an exemplary printer or printer system, shown as printer 102, is depicted, according to an example embodiment. The printer 102 can be a value-jet printer, a continuous inkjet printer, or another kind of printer that uses a pump to make prints. In the example shown, the printer 102 is a continuous inkjet printer. In some embodiments, the printer 102 is a different type of printer 102. The system 100 can include various types of printers 102 (e.g., not all the printer 102 on the system 100 are the same). The printer 102 may include a fluid reservoir 201. The fluid reservoir 201 can receive, store, and provide a fluid (e.g., ink) to the printer 102 for a print cycle. The printer 102 may include a pump 202 coupled to the fluid reservoir 201. The pump 202 can receive fluid from or draw fluid from the fluid reservoir 201. The pump 202 can pressurize the fluid. The printer 102 may include a nozzle 203 coupled to the pump 202. The pump 202 may provide the fluid to the nozzle 203. The nozzle 203 may receive the fluid from the pump 202 as a pressurized fluid stream. The nozzle 203 can separate the pressurized fluid stream into droplets. The droplets can exit the nozzle 203 and at least a portion of the droplets may exit the printer 102 and contact and apply to a substrate 204 (e.g., paper, container, etc.). The droplets that do not exit the printer 102 may return to the fluid reservoir 201.

The printer 102 may include at least one sensor. For example, the printer 102 may include a speed sensor 208. The speed sensor 208 may be configured to detect a speed of the pump 202. The speed sensor 208 can be disposed within the printer 102 and/or at any location that facilitates detection of the speed of the pump 202. For example, the speed sensor 208 can be coupled to or disposed in/on the pump 202. The printer 102 may include a pressure sensor 210. The pressure sensor 210 may be configured to detect a pressure of the pump 202. The pressure sensor 210 may be disposed within the printer 102 and/or at any location that facilitates detection of the pressure of the pump 202. For example, the pressure sensor 210 can be coupled to or disposed in the pump 202.

Referring to FIG. 2B, the printer 102 is shown according to an example embodiment in more detail. The printer 102 is shown as including a printer network interface 205. The printer network interface 205 facilitates connection of the printer 102 to the network 108. The printer network interface 205 can support communication via the network 108 between the provider computing system 104 and the printer 102 and/or between the user device 106 and the printer 102. The printer network interface 205 may include communications ports (e.g., Ethernet ports), routing capabilities, a cellular modem, a wireless transceiver or beacon, etc. In some embodiments, the printer network interface 205 includes cryptographic capabilities to establish a secure communications session.

The printer 102 is shown as including a printer processing circuit 206. The printer processing circuit 206 is structured to control, at least partly, the printer 102 and to execute or otherwise enable the various operations attributed herein to the printer 102. For example, the printer processing circuit 206 can execute the various processes shown in the figures and described in detail below. The printer processing circuit 206 includes memory (one or more non-transitory computer readable media) 214 and one or more processors 216. The processor(s) 216 may be implemented as one or more general-purpose processors, application specific integrated circuits (ASICs), field programmable gate arrays (FPGAs), digital signal processors (DSPs), other suitable electronic processing components, or a combination thereof. The memory 214 may be implemented as RAM, ROM, NVRAM, Flash Memory, hard disk storage, solid state storage, etc. and may store data and/or computer-readable instructions (programming, logic, code) for providing the features described herein. The memory 214 stores computer-readable instructions that, when executed by the processor(s) 216, causes the processor(s) 216 to perform some or all of the operations attributed herein to the printer processing circuit 206 and/or the printer 102.

The printer 102 is shown as including the pump 202. The pump 202 is structured to pump fluid, such as ink, through the printer 102 such that the printer 102 can execute a print cycle. For example, the pump 202 can pull ink from an ink supply (e.g., fluid reservoir 201) and cause the ink to flow to an outlet (e.g., nozzle 203) such that at least a portion of the ink is applied to a medium or substrate 204 (e.g., paper, packaging, etc.). The pump 202 can operate within an expected performance range. For example, an expected performance range may include a speed range and/or a pressure range. The performance of the pump 202 may change based on usage, time, environment, or various other factor. The pump 202 can be any type of pump capable of performing the functions described herein. For example, the pump 202 may be an air pump, hydraulic pump, gear pump, piston pump, among others.

The printer 102 is shown as including a first sensor, shown as speed sensor 208. The speed sensor 208 is structured to acquire data indicative of a speed of the pump 202 (e.g., determine, measure). For example, during a print cycle, the speed sensor 208 may measure a pump speed greater than a threshold (e.g., zero RPM). Outside of a print cycle, the speed sensor 208 may measure a pump speed equal to the threshold (e.g., zero RPM). The speed sensor 208 can be any kind of sensor capable of measuring pump speed (e.g., a tachometer) and can be disposed at any location within or on the printer 102 such that the speed sensor 208 can measure the pump speed.

The printer 102 is shown as including a second sensor, shown as pressure sensor 210. The pressure sensor 210 is structured to determine (e.g., detect, measure) a pressure of the pump 202. For example, during a print cycle, the pressure sensor 210 may measure a pump pressure greater than a threshold (e.g., zero psi). Outside of a print cycle, the pressure sensor 210 may measure a pump pressure equal to the threshold (e.g., zero psi). The pressure sensor 210 can be any kind of sensor capable of measuring pump pressure and can be disposed at any location within or on the printer 102 such that the pressure sensor 210 can measure the pump speed. For example, the pressure sensor 210 can be disposed at or proximate to an outlet of the pump 202 to measure the pump pressure when the ink exits the pump 202. In some embodiments, the printer 102 may have a first pressure sensor 210 disposed upstream of the pump 202 and a second pressure sensor 210 disposed downstream of the pump 202 to get a pressure differential across the pump 202. The pressure sensor 210 may be any type of pressure sensor including, but not limited to, a pressure gauge or a manometer.

The printer processing circuit 206 may be configured receive the information from the pressure and speed sensors, respectively, to track or monitor the speed and pressure of the pump 202 during operation of the printer 102. In one embodiment, the operation may be a predefined time period. In another embodiment, the operation may be a predetermined number of print cycles of the printer 102. The printer processing circuit 206 may be configured to determine that the pump 202 is activated or turned on. Activation/turned on may be based on the pump 202 operating above a predefined threshold speed (e.g., zero revolutions-per-minute (RPM)). Activation/turned on may also be based on other factors, such as an electrical parameter (e.g., voltage and/or current) indicative of a component (e.g., the pump 202) being energized. The printer processing circuit 206 may track a speed of the pump 202 while the pump is in an on state (i.e., turned on). For example, the printer processing circuit 206 may receive one or more signals from the speed sensor 208 indicative of the pump speed. The printer processing circuit 206 may track a pressure of the pump 202 when the pump is on. For example, the printer processing circuit 206 may receive one or more signals from the pressure sensor 210 indicative of the pump pressure during operation of the pump. Based on the received pump pressure and pump speed, the printer processing circuit 206 may correlate the pump speed with the pump pressure. For example, printer processing circuit 206 may correlate a pump speed at a point in time with a pump pressure at the same point in time. The printer processing circuit 206 may correlate any number of pump speeds with any number of pump pressures over one or more predefined periods of operation. In this way, each tracked pump speed may have a corresponding pump pressure.

The printer processing circuit 206 may be configured to provide a tracked pump speed and/or a tracked pump pressure to a remote computing system, such as the provider computing system 104 or another computing system remote from the printer 102, such as the user device 106. For example, the printer processing circuit 206, via the printer network interface 205, may be configured to transmit the tracked pump speed data and the tracked pump pressure data to the provider computing system 104 of the system 100.

The printer processing circuit 206 may be configured to initiate a diagnostic action based on the tracked pump speed and the tracked pump pressure (e.g., from a command(s) from the provider computing system 104). For example, the printer processing circuit 206, or a processing circuit of the provider computing system 104 (e.g., provider processing circuit 222), may be configured to determine that the tracked pump pressure indicates a decrease in pump pressure that exceeds an allowable pump pressure decrease threshold for a predefined time period. The predefined time period may be a time period of operation of the pump 202. The printer processing circuit 206, or the provider processing circuit 222, may be configured to determine that the tracked pump speed indicates an increase in pump speed that exceeds a pump speed increase threshold for the predefined time period or a pump speed that exceeds a pump speed threshold during the predefined time period. The printer processing circuit 206 may initiate the diagnostic action based on the determination that at least one of the pump speed or the pump pressure exceeds a predefined threshold. The diagnostic action may include, for example, operating the pump 202 at a predefined speed for a predefined time duration, shutting down the printer 102, and/or transmitting a notification to the user device 106.

The printer processing circuit 206 may be configured to generate a warning notification in response to at least one of the tracked pump speed or the tracked pump pressure exceeding a predetermined threshold. The printer processing circuit 206 may be configured to provide the warning to the provider computing system 104.

The printer 102 is shown as including an input/output (I/O) circuit 212. The input/output (I/O) circuit 212 can include various components for providing outputs and/or inputs of and to the printer 102. For example, the I/O circuit 212 can include a display screen, a touchscreen, a mouse, a button, a keyboard, a microphone, a speaker, an accelerometer, actuators (e.g., vibration motors), including any combination thereof, in various embodiments. The I/O circuit 212 may also include circuitry/programming/etc. for running such components. The I/O circuit 212 thereby enables communications to and from a user, for example communications relating to a quantity of print cycles, a speed of the pump 202, and/or a pressure of the pump 202 as described in further detail herein.

The provider computing system 104 may be managed by, owned by, and/or otherwise associated with a provider entity. The provider entity may be a provider of various products and/or services. For example, the provider entity may be an original equipment manufacturer, such as of the printer 102. As another example, the provider entity may be a provider of remote analytics, diagnostics, and/or prognostics. In the example shown, the provider is a provider of the printer 102 and provides intelligent analytics, diagnostics, and/or prognostics regarding the printers 102. The provider may provide and maintain a plurality of accounts associated with a plurality of printers. Each account associated with each printer may include or store performance data (e.g., pump speed, pump pressure, print cycle time, etc.), printer characteristics (e.g., age of pump 202, usage parameters regarding operation of the printer 102 (e.g., number of print cycles completed, details of previous print cycles and associated metrics), environmental operating condition of the printer 102, threshold breaches, location of the printer 102 etc.), and/or user information (e.g., contact information of user of the printer 102, etc.) regarding the printer 102.

The provider computing system 104 is shown as including a provider network interface 220, a provider processing circuit 222, and a provider database 224. The provider computing system 104 may be one or more backend server or cloud computing systems. The provider network interface 220 is structured to enable and facilitate connection of the provider computing system 104 to the network 108. The provider network interface 220 can support communication via the network 108 between the user device 106 and the provider computing system 104 and/or between the printer 102 and the provider computing system 104. The provider network interface 220 may include communications ports (e.g., Ethernet ports), routing capabilities, a cellular modem, a wireless transceiver or beacon, etc. in various embodiments. In some embodiments, the provider network interface 220 includes cryptographic capabilities to establish a secure communications session.

The provider computing system 104 is shown to include the provider processing circuit 222. The provider processing circuit 222 may be structured to collect, update, and/or analyze information received, obtained, and/or stored by the provider computing system 104 to identify or determine a status of a component (e.g., a pump 202, a sensor 208, 210, etc.) of a printer 102 and activate a response action 306 based on analysis of the component. As described in more detail below, in some embodiments, the one or more processors 228 of the provider processing circuit 222 may be configured to analyze data associated with the printer 102 or a component of the printer (e.g., pump 202), compare the data with predetermined thresholds, and initiate a response based on the comparison to confirm or respond to the analysis of the pump 202 of the printer 102. It should be understood that while the component is primarily pump 202, the component may be other components, such as the nozzle 203, the sensors 208, 210, or a printer head among others.

The provider processing circuit 222 is structured to control, at least partly, the provider computing system 104 and to execute or otherwise enable the various operations attributed herein to the provider processing circuit 222. For example, the provider processing circuit 222 can execute the various processes shown in the figures and described in detail below, The provider processing circuit 222 includes memory (one or more non-transitory computer readable media) 226 coupled to one or more processors 228. The processor(s) 228 may be implemented as one or more general-purpose processors, application specific integrated circuits (ASICs), field programmable gate arrays (FPGAs), digital signal processors (DSPs), other suitable electronic processing components, or a combination thereof. The memory 226 may be implemented as RAM, ROM, NVRAM, Flash Memory, hard disk storage, solid state storage, etc. and may store data and/or computer-readable instructions (programming, logic, code) for providing the features described herein. The memory 226 stores computer-readable instructions that, when executed by the processor(s) 228, causes the processor(s) 228 to perform some or all of the operations attributed herein to the provider processing circuit 222 and/or provider computing system 104.

The provider database 224 is structured to retrievably store (e.g., in non-transitory computer memory) data or information usable by the provider processing circuit 222 for providing various operations described herein. For example, the provider processing circuit 222 may be structured to read data from the provider database 224 and write data to the provider database 224. The provider database 224 can include various database components in various embodiments, for example memory in hard drive storage, disk storage, solid state storage, etc.

The user device 106 may be associated with a user of the printer, a provider associated with the provider computing system 104, and/or a technician or other individual capable of servicing the printer 102. In the example shown, the user device 106 is associated with a user who may be present at the location of the printer(s) 102. The user may be a worker, attendant, etc. who works at the location of the printer(s) 102. The user may be an employee of the provider entity associated with the provider computing system 104. In still other embodiments, the user may be a third-party relative to the provider and to the entity associated with the location that houses the printer(s) 102. For example, the third-party may be a third-party repair service for the printer.

The user device 106 may be a tablet computer, laptop computer, mobile device (e.g., smartphone), etc. In the example shown, the user device 106 is a separate computing device relative to the printer 102, and is a smartphone or a tablet computer. The user device 106 is shown as including a user device network interface 230 and a user device input/output (I/O) circuit 232. The user device network interface 230 is structured to enable and facilitate connection of the user device 106 to the network 108. The user device network interface 230 can support communication via the network 108 between the printer 102 and the user device 106 and/or between the provider computing system 104 and the user device 106. The user device network interface 124 may include one or more communication ports (e.g., Ethernet ports), routing capabilities, a cellular modem, a wireless transceiver or beacon (e.g., Bluetooth, near-field communication), etc. in various embodiments. In some embodiments, the user device network interface 124 includes cryptographic capabilities to establish a secure communications session.

The user device I/O circuit 232 may include various components for providing outputs to a user of the user device 106 and receiving inputs from a user of the user device 106. For example, user device I/O circuit 232 can include a display screen (e.g., a touchscreen), a button, a keyboard, a microphone, a speaker, an accelerometer, actuators (e.g., vibration motors), any combination thereof, etc. The user device I/O circuit 232 may also include circuitry and associated programming/etc. for running such components. The user device I/O circuit 232 thereby enables communications to and from a user, for example communications relating to pump performance and response actions as described in further detail herein.

In operation and via the network 108, the user device 106 may receive information regarding operation of the printer 102. The user device 106 may include one or more applications or programs that enable remote control of the printer 102. The user device 106 may communicate via any combination of wired and/or wireless (e.g., near-field communication, Bluetooth®, etc.) protocol with the printer 102. In some embodiments, a security syncing process may be utilized in order to only allow users with valid credentials to view data/information associated with the printer 102 and/or control the printer 102.

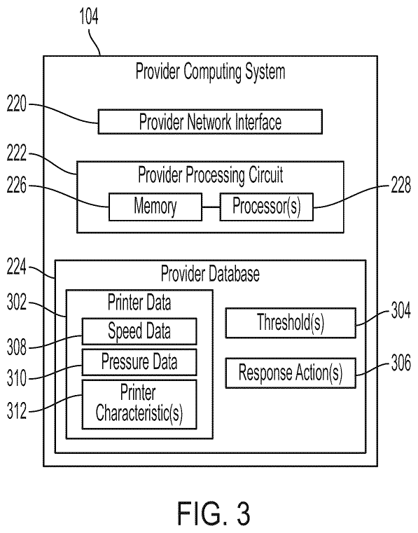

Referring to FIG. 3, the provider computing system 104 is shown in more detail, according to some embodiments. The provider computing system 104 is shown to include the provider database 224. The provider database 224 is structured to store printer data 302, one or more thresholds 304, one or more response actions 306 (also may be referred to as a “diagnostic action”), among potentially other data and/or information.

The printer data 302 refers to data regarding operation of the printer 102. The printer data may include, for example, speed data 308, pressure data 310, and at least one printer characteristic 312. The printer data 302 may include data associated with each printer 102 that is a part of the system 100 and stored in an account associated with each individual printer 102. In some embodiments, the one or more processors 228 of the provider processing circuit 222 may be configured to analyze the printer data 302 including at least one of the speed data 308 associated with a pump 202, pressure data 310 associated with the pump 202, and/or at least one printer characteristic associated with the printer 102, compare the printer data with the thresholds 304, and initiate a response action 306 based on the comparison to confirm or respond to the analysis of the pump 202 of the printer 102.

The speed data 308 may include a pump speed of a pump 202 of a printer 102, a number of times or instances the pump speed exceeds a speed threshold, an amount over or under the speed threshold the pump speed is at particular times of operation, a speed profile over various times of operation of the printer 102, among other data associated with the speed of the pump 202. The speed profile may be, for example, a visual display of the speed data 308 generated by plotting pump speeds on a graph to show a trend of the pump speeds over time (e.g., increase speed over time). The pressure data 310 may include a pump pressure of the pump 202 of the printer 102, a number of times or instances the pump pressure exceeds a pressure threshold, an amount over or under the threshold the pump pressure is at particular times of operation, a pressure profile over various times of operation of the printer 102, among other data associated with the pressure of the pump 202. The pressure profile may be, for example, a line graph depicting a change in pump pressure over time. The printer characteristics 312 may include other information regarding the printer 102, such as, for example, number of print cycles performed by a pump 202 of the printer 102, duration of a print cycle, age of the pump 202, purchase date, last maintenance, type of printer 102, location of the printer 102, and/or environment of the printer 102 (e.g., humidity, altitude), among other characteristics. The provider computing system 104 may be configured to receive the printer characteristics from user input or from data received from the printer 102. For example, the printer 102 may transmit various such data to the provider computing system 104.

The thresholds 304 may be a metric, value, range of values, etc. used to diagnose and indicate of a potential failure of a component, such as the pump 202, of the printer 102. A first threshold of the thresholds 304 may include a speed threshold. The speed threshold refers to a predetermined speed limit (e.g., a maximum speed). A pump 202 that exceeds the speed threshold may indicate that the pump 202 is approaching failure. A second threshold of the thresholds 304 may include a speed increase threshold. The speed increase threshold refers to a predetermined rate limit at which the speed can increase (e.g., maximum rate of speed increase). A pump 202 that exceeds the speed increase threshold (e.g., the speed of the pump 202 increases too fast) may indicate that the pump 202 is approaching failure. A third threshold of the thresholds 304 may include a pressure threshold. The pump pressure threshold refers to a predetermined pressure limit (e.g., a minimum pressure). Exceeding the pressure threshold may indicate that the pump 202 is approaching failure. A fourth threshold of the thresholds 304 may include a pressure decrease threshold. The pressure decrease threshold refers to predetermined limit for a rate at which the pressure can decrease (e.g., maximum rate of pressure decrease). A pump 202 that exceeds the pressure decrease threshold (e.g., the rate at which the pressure of the pump 202 decreases is above a predetermined rate) may not be generating enough pressure such that the fluid (e.g., ink) is not being delivered effectively. As such, a pump 202 that exceeds the pressure decrease threshold may indicate that the pump 202 is approaching failure. The thresholds 304 may include a count threshold. The count threshold refers to a predetermined number of times that the pump 202 can exceed any of the other thresholds 304. A pump 202 that exceeds the count threshold (e.g., the pump speed exceeds the speed threshold a predetermined number of times) may indicate that the pump 202 is approaching failure. Pump failure refers to a point at which the pump 202 can no longer function as intended and prevents the printer 102 from producing prints of a predetermined quality and/or at a predefined speed.

The provider database 224 may retrievably store thresholds that are tailored for a specific printer 102 type (e.g., continuous inkjet, laser jet, solid ink, etc.). For example, the thresholds 304 for a printer 102 may be based, at least in part, on the printer characteristics 312. A printer 102 with a pump that is more worn (e.g., an older pump 202, a pump 202 that has performed more print cycles, etc.) may have a higher speed threshold or a lower pressure threshold than a printer 102 with a pump that is less worn. A printer 102 in a relatively more humid environment may have different thresholds 304 than a printer 102 in a dry environment. The thresholds 304 may be dynamic such that the threshold 304 can change as printer characteristics change. For example, a threshold can change as a pump 202 gets older (e.g., as the pump operates for more hours), when a printer is moved to a different environment, and so on.

The response action 306 refers to a command/action initiated and caused based on analyzing the printer data 302 relative to one or more of the thresholds 304. For example, the response action 306 may be an action to verify the analysis or a status of the printer 102, or a component thereof (e.g., the pump 202), and/or an action to generate a notification that indicates a status of the printer 102, or a component thereof. The response action 306 may be initiated by the provider computing system 104 transmitting a command to the printer 102. The command may cause the printer to perform the desired response action 306. The provider computing system 104 can transmit the command from a remote location.

As an example, the response action 306 may cause the printer 102 to perform a performance test. The performance test may have at least one corresponding threshold 304 such that the performance of the printer 102 during the performance test may be compared to the corresponding at least one threshold to verify whether the printer 102, or a component thereof (e.g., the pump 202) is performing as intended. For example, the performance test may include performing a test operation that includes operating a component at a predetermined setting for a predetermined period of time (e.g., operating a pump 202 for a predetermined speed for a predetermined period of time), the test operation having a predetermined performance threshold 304, performing a test print cycle that has a predetermined performance threshold 304, and/or re-performing a cycle that was previously performed by the printer 102 that has a predetermined performance threshold that is based on performance metrics that were previously measured during the previous cycle. The thresholds may be, for example, a pressure of the pump 202 and/or a speed of the pump 202.

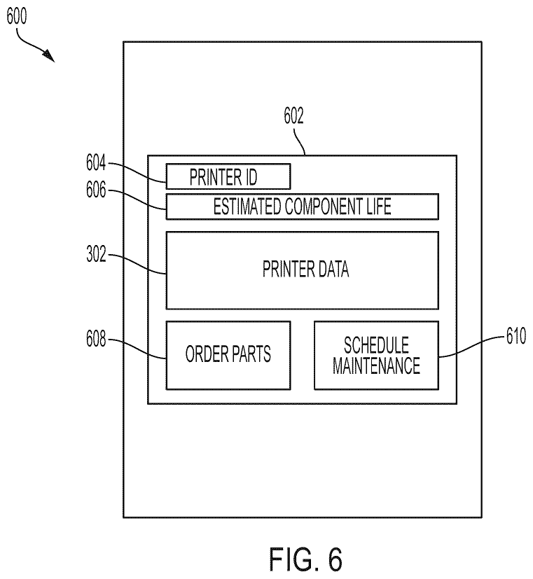

Another example response action 306 may be to transmit a notification to a user device 106 indicating a status of the printer 102, or a component thereof (e.g., the pump 202). For example, the notification may indicate that a component of the printer 102 is likely to fail within a predetermined time period. FIG. 6 depicts an example user interface 600 with a notification 602, which may also be referred to as an “impending failure notification” herein. A notification 602 may include at least one of a printer identifier 604 (e.g., serial number, other identifier, etc.), an estimated component life 606, printer data 302 (e.g., speed data 308, pressure data 310, printer characteristics 312, etc.), a selectable link to order a replacement component 608, a selectable link to schedule maintenance 610, etc. The notification 602 may include a reason for the impending component failure. The printer data 302 may also be displayed in a graphical form to display a pump speed or pump pressure. In some embodiments, the provider computing system 104 may determine an appropriate user device 106 to transmit the notification 602 based on the analysis. For example, if the provider computing system 104 determines pump failure is likely imminent (e.g., pump 202 will need to be replaced within a predefined short period of time, such as a week), the notification 602 may be transmitted to a technician located near the printer 102 such that the technician can attend to the pump 202 as soon as possible. If the provider computing system 104 determines pump failure is likely less imminent (e.g., more than a predefined amount of time), the notification 602 may be transmitted to a printer provider associated with the printer 102 such that the provider can order necessary parts and schedule an appointment to replace or repair the pump 202 or to the owner of the printer 102 such that the owner may schedule maintenance of the printer 102.

Another example response action 306 may be to compare the printer data 302 from the printer 102 with printer data 302 from a plurality of other printers 102. For example, a plurality of printers 102 may be connected to the network 108. Printer data 302 may be collected from the plurality of printers 102 to determine baseline thresholds 304 (i.e., thresholds or ranges associated with operation as intended or operation indicative of likely failure). In some embodiments, if a plurality of printers 102 provide similar printer data 302 (e.g., speed data 308, pressure data 310), the printer data 302 may indicate that some other component may be faulty (e.g., a sensor 208, 210) rather than the pump 202. For example, a presence of an error or trouble code may be used to verify the accuracy of certain data. For example, the printer data 302 may be from printers from the same location and from different locations. If multiple printers in the same location have the same error or trouble codes, the error may not be due to a failing pump, and further analysis may be required to identify the fault of the errors given the unlikelihood of all or many of the printers exhibiting the same failure mode at the same time.

The one or more processors 228 may be configured to receive, analyze, and manipulate printer data 302 associated with one or more printers 102. For example, during operation of a pump 202 of a printer 102, printer data 302 may be transmitted to and received by the provider computing system 104. In some embodiments, the printer data 302 may only be transmitted when the pump speed exceeds a threshold 304. Limiting data transmissions can reduce the total number of communications transmitted, the volume of data transmitted, and the volume of data that is to be analyzed, which can reduce the computation load on the provider computing system 104. As described above, the provider computing system 104 may be at remote location relative to the printer 102. The one or more processors 228 may be configured to receive speed data 308. The speed data 308 may be indicative of a pump speed associated with a pump 202 of a printer 102 over a period of operation. The one or more processors 228 may be configured to analyze the speed data 308 to identify trends, increases, decreases, or other metrics associated with the speed data 308. For example, the one or more processors 228 may compare speed data 308 across a time period to determine whether a speed of the pump 202 changes. For example, a speed of a pump 202 may have a first value at a first point in time during the time period and the speed of the pump 202 may have a second value at a second point in time during the time period. The one or more processors 228 may compare a difference between the first value and the second value to a threshold 304 (e.g., a speed increase threshold 304) or may compare the second value to a threshold 304 (e.g., a speed threshold 304) as part of determining a status of the pump 202.

The one or more processors 228 may generate and provide displays or user interfaces (e.g., charts, graphs, etc.) that depict the data, such as the speed data 308, over the period of time and show how the, for example, speed data 308 changes. For example, the one or more processors 228 may transform the speed data 308 into a visual display by plotting the pump speeds on a graph to show a trend of the pump speeds over time (e.g., increase speed over time). The one or more processors 228 may compare the plotted speed data with a predefined acceptable trend for pump speed (e.g., an acceptable increase in pump speed). When the plotted speed data 308 exceeds or does not follow the predefined acceptable trend, the one or more processors 228 may determine that the pump 202 is approaching failure.

The one or more processors 228 may be configured to receive pressure data 310. The pressure data 310 may be indicative of a pump pressure associated with a pump 202 of a printer 102 over a time period. The one or more processors 228 may be configured to analyze the pressure data 310 to identify trends, increases, decreases, or other metrics associated with the speed data 308. For example, the one or more processors 228 may compare pressure data 310 across a time period to determine whether a pressure of the pump 202 changes. For example, a pressure of a pump 202 may have a first value at a first point in time during the time period and the pressure of the pump 202 may have a second value at a second point in time during the time period. The one or more processors 228 may compare a difference between the first value and the second value to a threshold 304 (e.g., a pressure decrease threshold 304) or may compare the second value to a threshold 304 (e.g., a pressure threshold 304) to determine a status of the pump 202. Similar to the speed data 308, the one or more processors 228 may generate and provide displays that depicts the pressure data 310 over the period of time and show how the pressure data 310 changes.

The one or more processors 228 may be configured to receive an indication of a printer characteristic 312. For example, the one or more processors 228 may receive an indication of an age of a pump 202, usage parameters regarding operation of the printer 102 (e.g., number of print cycles completed, details of previous print cycles and associated metrics), environmental operating condition of the printer 102, a threshold breach (e.g., exceeding a threshold), and/or a location of the printer 102, among others. A threshold breach may include when a sensor 208, 210 (or other sensor) of a printer 102 detects a value that exceeds a predetermined threshold. For example, a threshold breach may include a pump speed exceeding a predetermined speed threshold or a pump pressure being below a predetermined pressure threshold 304. The threshold breach may be detected by a sensor 208, 210 and determined by the provider computing system 104 (or by the printer itself).

As part of diagnosing and troubleshooting each of the printers, the one or more processors 228 may be configured to identify a change in pump speed and a corresponding decrease in pump pressure for each printer 102. For example, the one or more processors 228 may receive speed data 308 for a pump 202 and pressure data 310 for the pump 202 for a predefined time period. The one or more processors 228 may determine that the pump speed changes during the same time period that the pump pressure decreases. The pump speed change may be an increase in pump speed over the time period. As such, the one or more processors 228 may identify an increasing pump speed and a corresponding decreasing pump pressure.

The one or more processors 228 may be configured to parse a subset of at least one of the speed data 308 and the pressure data 310 to identify data that exceeds a predefined threshold 304. For example, the one or more processors 228 may parse a subset of the speed data 308 to identify speed data 308 associated with a pump speed that is greater than a pump speed threshold 304. For example, the one or more processors 228 may identify a subset of the speed data 308 that is associated with a pump speed that is greater than zero RPMs. As such, the one or more processors 228 may only analyze speed data 308 associated with the pump 202 when the pump 202 is in use (e.g., speed is greater than zero RPMs). Analyzing only a subset of the received data reduces the computational load on the provider computing system 104 and can improve the speed and efficiency of the analysis. The one or more processors 228 may discard the remaining speed data 308 (e.g., the data not analyzed). Discarding the reaming speed data 308 reduces the burden on the computer storage systems (e.g., provider database 224). The one or more processors 228 may only analyze pressure data 310 that is associated with the speed data 308 that exceeds the pump speed threshold 304. For example, the one or more processors 228 may be configured to correlate the subset of the speed data to the pressure data over the time period such that the one or more processors 228 only analyzes pump pressure when the pump speed meets the threshold (e.g., when the pump 202 is in use and the speed is greater than zero RPMs).

The one or more processors 228 may be configured to generate a graphical user interface depicting the subset of the printer data 302. The graphical user interface may be displayed on a user interface of a computing device. The computing device may the user device 106. The user device 106 may be associated with the provider associated with the provider computing system 104, a user of the printer 102, or an individual capable of servicing the printer 102 (e.g., a technician), among others.

The one or more processors 228 may be configured to identify a change in pump speed based on the speed data 308. For example, the one or more processors 228 may be configured to identify an increase in pump speed. The one or more processors 228 may be configured to aggregate the speed data 308 over a period of time to compare the pump speeds during the period of time to identify the change in the pump speed. For example, the one or more processors 228 may be configured to receive raw speed data 308 (e.g., pump speed telemetry data). The one or more processors 228 may be configured to calculate an average, median, maximum, minimum, or other metric indicative of pump speed for various time windows within the period of time based on the raw speed data 308. A length or duration of a time window may vary based on the when the speed data 308 was measured. For example, the one or more processors 228 may analyze data measured over a year. Older speed data 308 (e.g., data measured toward the beginning of the year) may be aggregated over a month time window to identify a first average pump speed. Newer speed data 308 (e.g., speed data 308 measured toward the end of the year) may be aggregated over a week time window to identify a second average pump speed. The variations in duration of the time windows can capture an increasing change in pump speed as the pump 202 may approach failure. The period of time may be broken into any number and any length of time windows. The frequency of the time windows may increase as the time approaches potential pump failure. For example, at the beginning of the year, the pressure data 310 may be aggregated to generate an average or median pressure every other month. Closer to the end of the year, the pressure data may be aggregated to generate an average or median pressure every month or every 15 days or every 7 days. The one or more processors 228 may compare the average or median (or other metric) pump speeds to identify a change in the pump speed. When a later average pump speed (e.g., the second pump speed) is greater than a previous pump speed (e.g., the first pump speed), the one or more processors 228 may identify an increase in pump speed.

The one or more processors 228 may be configured to track and count the number of instances the pump speed reaches or exceeds a predetermined speed threshold 304. For example, the one or more processors 228 may determine how many times in a predetermined time period (e.g., every day) the pump speed reaches the threshold 304.

The one or more processors 228 may be configured to identify a change in pump pressure based on the pressure data 310. For example, the one or more processors 228 may be configured to identify a decrease in pump pressure. Similar to the speed data 308, one or more processors 228 may be configured to aggregate the pressure data 310 over a period of time to identify maximum pump pressures of the period of time and compare the maximum pump pressures to identify the change in the pump pressure. For example, the one or more processors 228 may be configured to aggregate the pressure data 310 over a period of time to compare the pump pressures during the period of time to identify the change in the pump pressure. For example, the one or more processors 228 may be configured to receive raw pressure data 310 (e.g., pump pressure telemetry data). The one or more processors 228 may be configured to identify an average, median, maximum, minimum, or other metric indicative of pump pressure for various time windows within the period of time based on the raw speed data 308. A length or duration of a time window may remain constant for each pressure median or average. For example, the one or more processors 228 may analyze data measured over a year. Older pressure data 310 (e.g., data measured toward the beginning of the year) and newer pressure data 310 may be aggregated over a month time window to identify maximum pump pressures. The duration of the time windows may remain constant since a drop in maximum ink pressure may decrease linearly with time. The period of time may be broken into any number and any length of time windows. The frequency of the time windows may increase as the time approaches potential pump failure. For example, at the beginning of the year, the pressure data 310 may be aggregated to generate a maximum pressure every other month. Closer to the end of the year, the pressure data may be aggregated to generate a maximum pressure every month. The one or more processors 228 may compare the maximum (or other metric) pump pressures to identify a change in the pump pressure. When a later maximum pump pressure (e.g., the second pump pressure) is less than a previous pump pressure (e.g., the first pump pressure), the one or more processors 228 may identify a decrease in pump pressure.

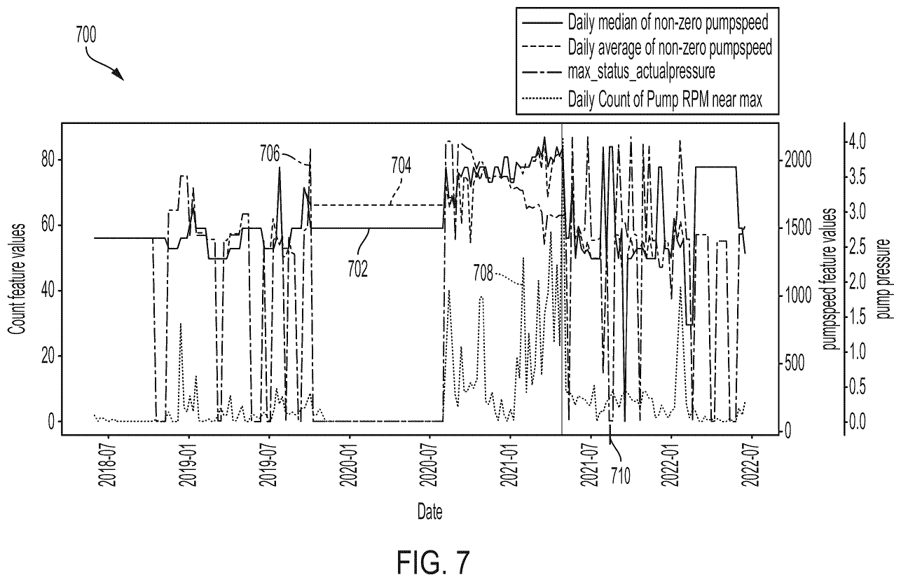

The change in pump pressure can correspond to the identified change in pump speed. For example, the one or more processors 228 may identify a change in pump speed that occurs at the same time as the change in the pump pressure. In some embodiments, the one or more processors 228 may identify an increase in pump speed and a corresponding decrease in pump pressure. For example, referring to FIG. 7, a graph 700 displaying a median pump speed 702, an average pump speed 704, a maximum pump pressure 706, and a count 708 of how many times the pump speed reached a threshold value is shown, according to an example embodiment. A bottom axis of the graph is a time axis such that a pump speed 702, 704 is depicted at the same time as a pump pressure 706. The graph 700 illustrates that an increase in pump speed with a correlating decrease in pump pressure can indicate failure of a pump. For example, as shown at time point 710, the median pump speed 702 and the average pump speed 704 peak and the maximum pump pressure 706 plummets, indicating a pump failure.

The one or more processors 228 may be configured to compare the printer data 302 with a threshold 304. The threshold 304 may be specific to the printer 102. For example, the threshold 304 may be based on a printer characteristic 312 of the printer 102. The one or more processors 228 may be configured to receive the printer characteristic 132. For example, a user may input a printer characteristic 312 via a user device that is transmitted to the provider computing system 104 or the printer 102 may have a printer characteristic 312 programmed into the printer that may be transmitted to or read by the provider computing system 104. The printer characteristic 312 may include at least one of a type of printer 102 (e.g., continuous inkjet printer, etc.), an age of the printer 102 or components thereof, an environmental operating condition of the printer 102 (e.g., humidity, etc.), or a usage parameter regarding operation of the printer 102 or components thereof (e.g., hours of operation, number of print cycles performed, etc.).

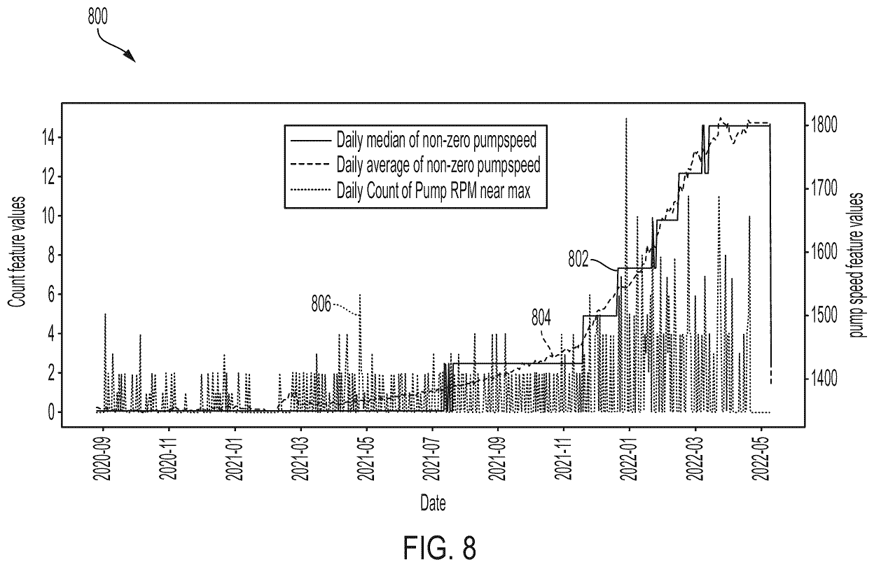

The one or more processors 228 may be configured to modify a threshold 304. For example, the one or more processors 228 may modify a threshold 304 based on a change in a printer characteristic 312. For example, referring to FIG. 8, a graph 800 displaying a median pump speed 802 and an average pump speed 804 of a pump 202 is shown, according to an example embodiment. A bottom axis of the graph is a time axis, such that a change in pump speed 802, 804 is depicted over time. The graph 800 illustrates that a speed 802, 804 of a pump 202 may increase over time without immediately indicating impending pump failure. For example, as shown, the median pump speed 802 and the average pump speed 804 may increase over a period of time (e.g., as the printer 102 gets older based on, for example, an hours of operation metric) at a more gradual rate before the rate of increase may reach a threshold 304 indicating impending pump failure. The speed increase may be a result of requiring a higher speed to maintain a target pressure as the pump 202 continues to wear. The one or more processors 228 may increase the speed threshold 304 after the printer 102 operates for a predetermined number of hours to accommodate the increase in median pump speed 802 and average pump speed 804. Graph 800 also includes a count 806 for a number of times the pump speed reaches a speed threshold 304. As shown, the count 806 may also increase with age of the pump 202. As such, the one or more processors 228 may increase a count threshold 304 accordingly.

The one or more processors 228 may be configured establish a threshold based on printer data 302 from a plurality of printers 102. For example, the one or more processors 228 may be configured to receive speed data 308 associated with a plurality of pumps 202. Each of the plurality of pumps 202 may be associated with a different printer 102. The one or more processors 228 may also be configured to receive pressure data 310 from the plurality of pumps 202. The one or more processors 228 may be configured to identify a plurality of failure occurrences for the plurality of pumps 202 based on the speed data 308 and the pressure data 310 associated with each of the plurality of pumps 202. Based on the plurality of failure occurrences, the one or more processors 228 may be configured to determine a plurality of representative thresholds. For example, the one or more processors 228 may determine a plurality of representative allowable pump pressure decrease thresholds for a plurality of associated ranges of changes in pump speeds based on the plurality of failure occurrences. The one or more processors 228 may be configured to modify a preexisting threshold 304 based on the threshold 304 determined from the printer data 302 from the plurality of printers 102. For example, the one or more processors 228 may modify an allowable pump pressure decrease threshold 304 based on at least one of the plurality of representative allowable pump pressure decrease thresholds 304.

The one or more processors 228 may be configured to determine that printer data 302 exceeds a threshold 304 based on the comparison of the printer data 302 with the threshold 304. For example, the one or more processors 228 may determine that a change in pump speed exceeds an allowable pump speed increase threshold 304 (e.g., the pump speed increased too quickly). The one or more processors 228 may determine that a pump speed exceeds an allowable pump speed (e.g., pump speed is above a predetermined speed). The one or more processors 228 may determine that a change in pump pressure exceeds an allowable pump pressure decrease threshold 304 (e.g., pump pressure decreased too quickly). The one or more processors 228 may determine that the pump pressure exceeds an allowable pump pressure (e.g., pump pressure is below a predetermined pressure).

Another threshold may include a count. The count may be a number of times that the printer data 302 meets or exceeds or otherwise does not comply with one or more of the thresholds 304. The one or more processors 228 may be configured to compare the count with a count threshold 304. For example, the pump speed may exceed a speed threshold 304 a single time. A single instance of exceeding the speed threshold 304 may indicate that the pump 202 was working under unique circumstances at that one time that caused the spike in pump speed. The pump may exceed the speed threshold 304 a predetermined number of times (e.g., the count threshold 304). The consistency of the pump speed exceeding the speed threshold 304 may be a result of the pump approaching failure, rather than a result of an isolated, unique set of circumstances.

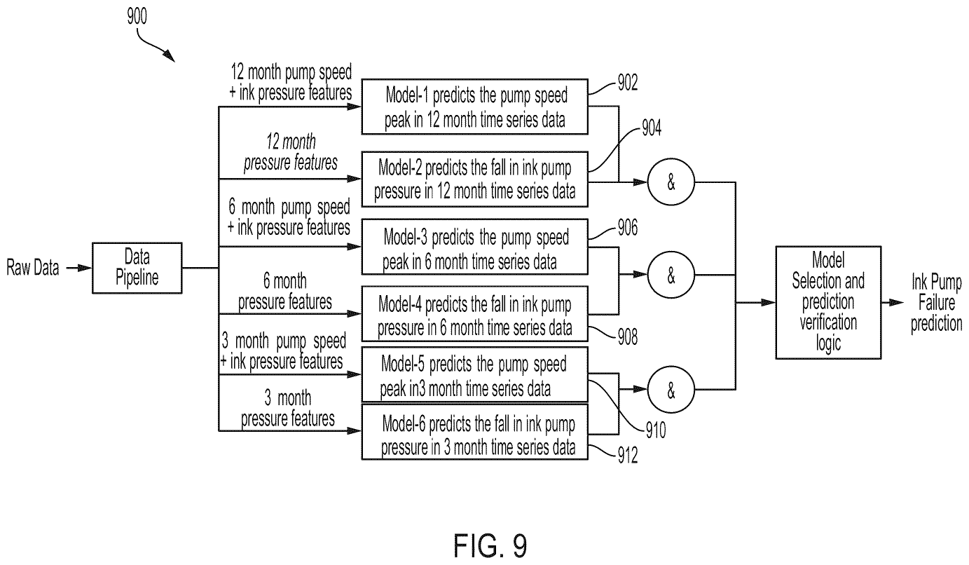

Referring to FIG. 9, a model architecture 900 that may be used by the provider computing system 104 and stored in the provider database 224 is shown, according to an example embodiment. The model architecture 900 may be a program or a set of instructions executed by the one or more processors 228. The model architecture 900 can cause the one or more processors to receive and analyze the raw printer data 302 to predict when a pump 202 may fail. For example, one or more of the models of the model architecture may predict a peak and slope of an increasing pump speed using the processed an aggregated speed data 308 and pressure data 310. One or more of the models may predict a trough of a decreasing pump pressure using the processed and aggregated pressure data 310. The one or more models may make such predictions over different time window durations.

A first model (Model-1 902) of the model architecture 900 may predict or determine a pump speed peak and/or slope based on speed data 308 and pressure data 310 from the previous twelve months. A second model (Model-2 904) may predict or determine a fall in pump pressure based on pressure data 310 from the previous twelve months. A third model (Model-3 906) may predict or determine the pump speed peak and/or slope based on speed data 308 and pressure data 310 from the previous six months. A fourth model (Model-4 908) may predict or determine the fall in pump pressure based on pressure data 310 from the previous six months. A fifth model (Model-5 910) may predict or determine the pump speed peak and/or slope based on the speed data 308 and the pressure data 310 from the previous three months. A sixth model (Model-6 912) may predict or determine the fall in pump pressure based on pressure data 310 from the previous three months. The one or more processors 228 may compare the pump speed peak and/or slope predictions and the fall in pressure predictions to predict when a pump 202 will fail.

Models 1, 3, and 5 902, 906, 910 may be fully connected neural networks with a first architecture. The first architecture may include first layer (e.g., an input layer) of 100 neural units with RELU activation and batch normalization. The first architecture may include a second layer with 50 neural units with RELU activation and batch normalization. The first architecture may include a third layer with 25 neural units with RELU activation and batch normalization. The first architecture may include a fourth layer (e.g., an output layer) with 1 neural unit with Sigmoid Activation function. The first architecture may incorporate or use a binary cross entropy loss function, and Adam optimizer, a learning rate of 0.0001, a batch size of 10, and Epochs of 200.

Models 2, 4, and 6 904, 908, 912 may be fully connected neural networks with a second architecture. The second architecture may include a first layer (e.g., an input layer) of 50 neural units with RELU activation and batch normalization. The second architecture may include a second layer with 30 neural units with RELU activation and batch normalization. The second architecture may include a third layer with 15 neural units with RELU activation and batch normalization. The second architecture may include a fourth layer (e.g., an output layer) with 1 neural unit with Sigmoid Activation function. The second architecture may incorporate or use a binary cross entropy loss function, and Adam optimizer, a learning rate of 0.0001, a batch size of 10, and Epochs of 200.

The one or more processors 228 may be configured to initiate a response action 306 based on a determined status of a component of a printer 102. For example, the one or more processors 228 may initiate the response action 306 based on an identification of a change in pump speed and a corresponding decrease in pump pressure that exceeds an allowable pump pressure decrease threshold 304 for the time period. The response action 306 may include actuating a printer 102 and/or generating a notification 602. Generating a notification 602 may include the one or more processors 228 providing a notification 602 to at least one of a local computing device at a location of the printer 102 or a computing device (e.g., user device 106) remote from the location of the printer 102. For example, the one or more processors 228 may be configured to provide the notification 602 to a computing system (e.g., user device 106) associated with a technician for the printer.

The one or more processors 228 may provide the notification 602 before a predefined failure condition of the pump is received. For example, the one or more processors 228 may provide the notification 602 to a user device 106 before a pump 202 of the printer 102 actually fails. This allows the recipient of the notification 602 (e.g., technician, printer supplier, pump manufacturer, etc.) to anticipate the maintenance that the printer 102 will require such that the owner or user of the printer 102 may not experience down time when the printer 102 is not functioning properly.

Actuating the printer 102 may include the one or more processors 228 being configured to at least one of operate the pump 202 of the printer 102 at a predetermined speed for a predetermined duration or cause the printer 102 to complete a predefined print cycle. The one or more processors 228 may wirelessly cause a pump 202 of the printer 102 to perform the response action 306. For example, the one or more processors 228 may be located physically separate from the printer 102 (e.g., disposed at a location remote from the printer 102) and transmit a command to the printer 102 to initiate the response action 306.

The one or more processors 228 may be configured to receive data regarding operation of the pump 202 during the response action. For example, the response action 306 may cause the pump 202 of the printer 102 to operate at a predefined speed for a predefined time duration. Speed data 308 and/or pressure data 310 associated with the pump 202 during the response action 306 may be transmitted to a remote computing system. For example, the data 308, 310 may be wirelessly transmitted to the provider computing system 104.

The one or more processors 228 may be configured to determine that the operation of the pump 202 diverges from an expected operation based on the received data regarding the operation of the pump 202 during the response action 306. For example, the one or more processors 228 may compare the received data from the response action 306 to a predetermined threshold 304 associated with the response action 306. The one or more processors 228 may identify a difference between the threshold 304 and the received data. The difference may indicate that the pump 202 is not working as intended and may be progressing toward failure. For example, the response action 306 may include the pump running at a designated speed for a designated duration. A threshold 304 may indicate an expected pump pressure for such an operation. If the received data diverges from the expected pump pressure a threshold amount, the divergence may indicate impending failure of the pump 202.

The one or more processors 228 may be configured actuate or initiate more than one response action 306. For example, the one or more processors 228 may initiate a first response action 306 to actuate the pump 202 to perform a test cycle. The one or more processors 228 may initiate a second response action 306 based on the determination from the first response action 306. For example, if the one or more processors 228 determines that the pump 202 is close to failure (e.g., will likely fail within the next six months), the one or more processors 228 may be configured to initiate the second response action 306 and generate and transmit a notification 602 indicative of the impending failure.

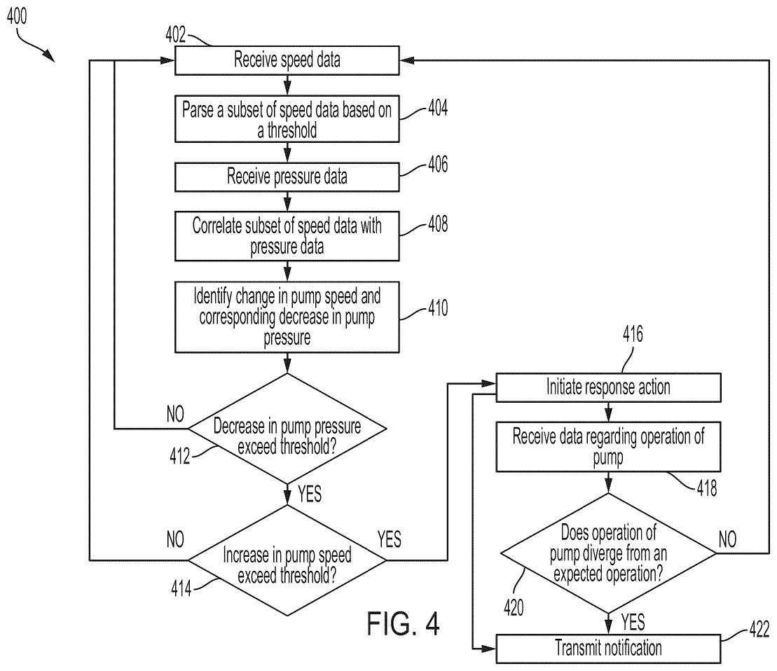

Referring now to FIG. 4 and with the above in mind, a process 400 to predict printer component, such as printer pump 202, failure is shown and may be described as follows. While process 400 is described as being performed via the provider computing system 104, some or all of the steps may also be performed by other components of the system 100 (e.g., the printer 102, the user device 106). Process 400 may include receiving, by the provider computing system 104, speed data 308 (step 402). The speed data 308 may include pump speed of a pump 202 of a printer 102. The speed data 308 may include raw data, comparative data, or averaged data, among others.

Process 400 may include parsing, by the provider computing system 104, the speed data 308 based on a threshold 304 (step 404). For example, the provider computing system 104 may analyze and/or store only the speed data 308 that exceeds a threshold 304. For example, the threshold 304 may be a speed of greater than zero. In this way, the provider computing system 104 only analyzes speed data 308 of the pump 202 when the pump 202 is on/actuated.

Process 400 may include receiving, by the provider computing system 104, pressure data 310 (step 406). The pressure data 310 may include pump pressure of the pump 202 of the printer 102 during a period of operation that coincides with the period of operation of the speed data. The pressure data 310 may include raw data, comparative data, or averaged data, among others.

Process 400 may include correlating, by the provider computing system 104, the subset of the speed data 308 with the pressure data 310 (step 408). For example, the subset of the speed data 308 may be associated with a specific period in time. The provider computing system 104 may correlate the subset of the speed data 308 with pressure data 310 associated with the same period in time.

Process 400 may include identifying, by the provider computing system 104, a change in pump speed and a corresponding decrease in pump pressure (step 410). For example, the provider computing system 104 may identify an increase in pump speed that occurs during the same period in time as a decrease in pump pressure.

Process 400 may include determining, by the provider computing system 104, whether the decrease in the pump pressure exceeds a pressure threshold 304 (step 412). For example, the provider database 224 may include a pressure threshold 304 that indicates an expected pump pressure or an expected decrease in pump pressure for when the pump 202 of the printer 102 is operating. The pressure threshold 304 may be tailored specifically to the specific pump 202. For example, the pressure threshold 304 may be based on any individual or combination of printer characteristics 312. The provider computing system 104 may compare the identified decrease in pump pressure with the pressure threshold 304. The provider computing system 104 may determine the identified decrease in pump pressure exceeds the pressure threshold 304 when the pump pressure decreases at a rate that is faster than the rate pressure threshold 304. In some embodiments, the pressure threshold 304 may be a pressure value. For example, the provider computing system 104 may determine the identified pump pressure exceeds the pressure threshold 304 when the pump pressure reaches a value lower than the pressure threshold 304.

If the decrease in pump pressure does not exceed the pressure threshold 304 (e.g., rate of pressure decrease is less than a threshold rate or pressure value is greater than a threshold value), process 400 may return to step 402. If the decrease in pump pressure does exceed the pressure threshold 304 (e.g., rate of pressure decrease is greater than a threshold rate or pressure value is less than a threshold value), process 400 may include determining, by the provider computing system 104, whether the pump speed exceeds a speed threshold 304 (step 414). For example, the provider database 224 may include a speed threshold 304 that indicates an expected pump speed or an expected increase in pump speed for when the pump 202 of the printer 102 is operating. The speed threshold 304 may be tailored specifically to the specific pump 202. For example, the speed threshold 304 may be based on any individual or combination of printer characteristics 312. The provider computing system 104 may compare the identified change in pump speed with the speed threshold 304. The provider computing system 104 may determine that the identified change in pump speed exceeds the speed threshold 304 when the pump speed increases at a rate faster than the speed threshold 304. In some embodiments, the speed threshold 304 may be a speed value. For example, the provider computing system 104 may determine the identified pump speed exceeds the speed threshold 304 when the pump speed reaches a value above the speed threshold 304.

Exceeding at least one of the pressure threshold 304 and the speed threshold 304 may indicate that the pump 202 is close to failure (e.g., will likely fail within the next six months). The provider computing system 104 may be able to estimate a remaining life of the pump based on how much the identified speed and pressure exceeds the respective thresholds 304. For example, if the identified speed or pressure exceeds the threshold 304 by a first predetermined amount (e.g., 10%, etc.) or less, the remaining life may be a first predetermined time frame (e.g., around six months, etc.). If the identified speed or pressure exceeds the threshold by a second predetermined amount (e.g., 30%, etc.) or more, the remaining life may be a second predetermined time frame (e.g., less than six months, less than three months, etc.).

Comparing the printer data 302 with the thresholds 304 may include updating the thresholds 304. For example, the provider computing system 104 may update the thresholds based on any one or combination of printer characteristics 312. In some embodiments, the provider computing system 104 may update the thresholds based on printer data 302 obtained from other printers 102. For example, the provider computing system 104 may receive and monitor printer data 302 from a plurality of printers 102. The printer data 302 may indicate that several printers 102 have failed around the time when speed data of the printers 102 indicated an identified speed value and when the pressure data 310 indicated an identified pressure value. The provider computing system 104 may update the thresholds 304 for other printers to match the identified speed value and pressure value.

If the pump speed does not exceed the speed threshold 304, process 400 may return to step 402. If the pump speed does exceed the speed threshold 304, process 400 may include initiating, by the provider computing system 104, a response action 306 (step 416). In some embodiments, the response action may include generating and transmitting a notification 602 to a remote computing device. The remote computing device may be a user device 106 associated with a provider associated with the provider computing system 104, a user of the printer 102, an individual or organization capable of servicing the printer, or a manufacturer of the pump 202, among others. The notification 602 can indicate that the pump (or other component) is going to fail in an estimated amount of time. The notification 602 may include a display of the printer data 302, links to order parts or schedule service, or other information associated with the component or the maintenance thereof.

In some embodiments, initiating a response action 306 may include actuating the pump 202 of the printer 102 (or another printer component(s)). The provider computing system 104 may actuate the pump to perform a specific cycle. For example, the provider computing system 104 may actuate the pump to operate at a designated speed for a designated period of time. In some embodiments, the provider computing system 104 may actuate the pump to repeat a print cycle that was done previously. A print cycle may refer to a predefined set of operations that enable a print to occur (e.g., movement of a print head, valve opening for ink to flow to nozzle, pump pressurized, etc.). The provider computing system 104 may actuate the pump to perform a test operation with known or expected performance metrics.

In some embodiments, initiating a response action 306 may include comparing the printer data 302 from the printer 102 with printer data 302 from a plurality of other printers 102. Based on the comparison, the provider computing system 104 may determine that instead of the pump 202 being faulty, there may be an issue with a different component (e.g., speed sensor 208, pressure sensor 210, etc.). For example, if a plurality of printers 102 have similar speed data 308 and pressure data 310, the provider computing system 104 may flag the plurality of printers 102 to indicate that some other component may be faulty. The provider computing system 104 may flag the plurality of printers 102 if the number of printers 102 reaches a threshold 304.

In some embodiments, the provider computing system 104 may initiate more than one response action 306. For example, the provider computing system 104 may compare the printer data 302 of the suspect printer 102 with printer data 302 of various other printers 102 before actuating the pump 202 to perform a test cycle, and transmit a notification 602 to a remote computing system after the pump performs the test cycle.

When the response action includes a test cycle, process 400 may include receiving, by the provider computing system 104, operating or performance data regarding operation of the pump 202 during the response action 306 (step 418). For example, the provider computing system 104 may receive speed data 308 and/or pressure data 310 associated with the pump 202 during the test cycle. The provider computing system 104 may compare the received operating data with expected thresholds 304 or previous operating data and determine whether the performance data diverges from expected performance data (step 420). Diverging from the expected performance data may indicate that the pump 202 is approaching failure within a predetermined amount of time.

If the performance data does not diverge from the expected performance data, process 400 may return to step 402. If the performance data does diverge from the expected performance data, process 400 may include transmitting, by the provider computing system 104, a notification 602 (step 422). For example, after the test cycle, if the provider computing system 104 determines the pump 202 (or other component) is approaching failure within a predetermined time, the provider computing system 104 may transmit the notification 602 to a remote computing system. The notification 602 may include at least one of an estimated time until the component fails, a location of the associated printer 102, a link to order a replacement component, component performance data, a reason for the impending component failure, or a link to schedule maintenance, among others.

The type of notification 602, the content of the notification 602, and where the notification 602 is transmitted may be based, at least partially, on the urgency of the pump failure. For example, a provider associated with the provider computing system 104 may have user device 106 configured to display a plurality of printers 102 that are connected to the network 108. When the a pump 202 of one of the plurality of printers 102 is predicted to fail within six months, a notification 602 may be transmitted to the user device 106 such that the failing printer 102 is highlighted or emphasized on the user interface of the user device 106. When the pump 202 is predicted to fail within one month, the notification 602 may be an email to the user device 106 and to a user device associated with the user or owner of the printer 102 that includes details about the failure (e.g., expected time window, printer data 302 that was relied on in making the determination of impending failure, etc.). When the pump 202 is predicted to fail within one week, the notification 602 may be a pop up window on the provider user device 106 that includes a link to schedule maintenance or order a new pump 202.

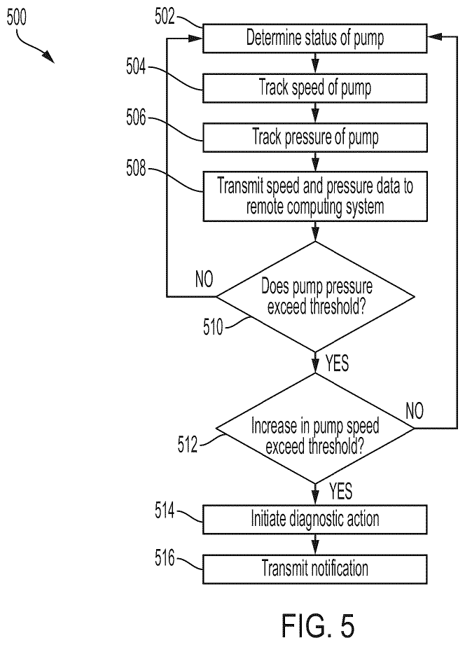

Referring now to FIG. 5 and with the above in mind, a process 500 to predict printer component, such as printer pump 202, failure may be described as follows. While process 500 is described as being performed via the printer 102, some or all of the steps may also be performed by other components of the system 100 (e.g., provider computing system 104, user device 106). Process 500 may include determining, by the printer 102, a status of a pump 202 (step 502). The printer 102 may determine that the pump is on. Process 500 may include tracking, by the printer 102, a speed of the pump 202 (step 504). For example, as the pump 202 performs a print cycle, the printer 102 may detect, via the speed sensor 208, the speed data 308 associated with the pump 202 (e.g., a speed of the pump 202). Process 500 may include tracking, by the printer 102, a pressure of the pump 202 (step 506). For example, as the pump 202 performs a print cycle, the printer 102 may detect, via the pressure sensor 210, pressure data 310 associated with the pump 202 (e.g., a pressure of the pump 202).

Process 500 may include transmitting, by the printer 102, the speed data 308 and the pressure data 310 to a remote computing system (step 508). For example, the printer 102 may transmit the speed data 308 and the pressure data 310 to the provider computing system 104. The data 308, 310 may include raw data, aggregated data, a subset of the data including only the data the meets a certain threshold 304, etc.

The process 500 may include determining, by the printer 102, whether a pump pressure exceeds a pressure threshold 304 (step 510). For example, the printer 102 may store, or receive from the provider computing system 104, a pressure threshold, and compare the pump pressure from the pressure data 310 with the pressure threshold 304. If the pump pressure does not exceed the pressure threshold 304, process 500 may return to step 502. If the pump pressure does exceed the pressure threshold 304, process 500 may include determining, by the printer 102, whether a pump speed exceeds a speed threshold 304 (step 512). For example, the printer 102 may store, or receive from the provider computing system 104, a speed threshold 304, and compare the pump speed from the speed data 308 with the speed threshold 304. If the pump speed does not exceed the speed threshold 304, process 500 may return to step 502. If the pump speed does exceed the speed threshold 304, process 500 may include initiating a diagnostic action (step 514). The diagnostic action may be any function that facilitates determining or verifying a status of the pump 202. For example, the diagnostic action may include a response action 306. Based on data obtained as a result of the diagnostic action, the printer 102 may determine that the pump 202 is approaching failure within a predetermined time window (e.g., six months). Based on the pump 202 approaching failure, process 500 may include transmitting, by the printer 102, a notification 602 (step 516). The notification 602 may include information associated with the failing pump 202. The notification 602 may be transmitted to a provider associated with the provider computing system 104, a user device 106 associated with a user of the printer 102, or an individual or organization capable of servicing the printer 102.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

With the above in mind, below is an example operation of the systems described herein. The provider computing system 104 can receive data regarding the performance of the printer 102, and more specifically the pump 202 of the printer 102. For example, the provider computing system 104 can receive pump speed data 308 and pump pressure data 310. The provider computing system 104 can track such data and continue to receive new data over time. The provider computing system 104 can identify a subset of the data that is not useful for analysis of the pump 202 and discard the subset of data. For example, the provider computing system 104 may discard data that relates to a period in time when the pump 202 is turned off and not operating. The provider computing system 104 can analyze the tracked data to identify a change in speed that exceeds a speed threshold occurs simultaneously, or nearly simultaneously, with a decrease in pressure that exceeds a pressure threshold. The provider computing system 104 can determine that the identified speed and pressure is not due to other trouble codes by comparing the metrics with other printer 102 on the system. For example, if other printers 102 in the same location all have the same error code, there may be a different issue that is not related to pump failure (e.g., faulty sensors). When the provider computing system 104 determines that the spike in speed and decrease in pressure is likely due to a failing pump 202, the provider computing system 104 can generate a notification that can be sent to a provider, manufacturer, technician, or any party that is capable of servicing the printer 102 with the pump 202 that is approaching failure.

It should be understood that while the steps described in the above example refer to operations of the provider computer system, in some embodiments, some or all of the functions may be performed by other components of the system 100 (e.g., the printer 102).

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A method, comprising:
receiving, by one or more processing circuits, speed data indicative of a pump speed over a time period, the speed data associated with a pump of a printer;
receiving, by the one or more processing circuits, pressure data indicative of a pump pressure over the time period, the pressure data associated with the pump;
identifying, by the one or more processing circuits, a change in pump speed and a corresponding decrease in pump pressure exceeding an allowable pump pressure decrease threshold for the time period; and
initiating, by the one or more processing circuits, a response action based on the identification of the change in pump speed and the corresponding decrease in pump pressure exceeding the allowable pump pressure decrease threshold for the time period.

2. The method of claim 1, further comprising:
parsing, by the one or more processing circuits, a subset of the speed data to identify speed data associated with pump speeds greater than a predefined threshold value; and
correlating, by the one or more processing circuits, the subset of the speed data to the pressure data over the time period.

3. The method of claim 1, further comprising:
receiving, by the one or more processing circuits, an indication regarding the pump speed of the pump exceeding a predefined threshold.

4. The method of claim 1, wherein the one or more processing circuits are located physically separate from the printer, and the method further comprises:
wirelessly causing, by the one or more processing circuits, the pump to perform the response action;
receiving, by the one or more processing circuits, data regarding operation of the pump during the caused response action;
determining, by the one or more processing circuits, that the operation of the pump diverges from an expected operation based on the received data regarding the operation of the pump during the caused response action; and
providing, by the one or more processing circuits, a notification to at least one of a local computing device at a location of the printer or a computing device remote from the location of the printer.

5. The method of claim 1, further comprising:
receiving, by the one or more processing circuits, a characteristic of the printer comprising at least one of an age of the printer, an environmental operating condition of the printer, or a usage parameter regarding operation of the printer; and
modifying, by the one or more processing circuits, the allowable pump pressure decrease threshold for a corresponding change in pump speed based on the at least one of the age of the printer, the environmental operating condition of the printer, or the usage parameter regarding operation of the printer.

6. The method of claim 1, wherein the response action comprises at least one of operating the pump of the printer at a predetermined speed for a predetermined duration or completing a predefined print cycle.

7. The method of claim 1, wherein the one or more processing circuits are located in a location remote from a location of the printer.

8. The method of claim 1, further comprising:
receiving, by the one or more processing circuits, speed data associated with a plurality of pumps, each of the plurality of pumps associated with a plurality of different printers;
receiving, by the one or more processing circuits, pressure data associated with the plurality of pumps;
identifying, by the one or more processing circuits, a plurality of failure occurrences for the plurality of pumps based on the speed data associated with the plurality of pumps and the pressure data associated with the plurality of pumps;
determining, by the one or more processing circuits, a plurality of representative allowable pump pressure decrease thresholds for a plurality of associated ranges of changes in pump speeds based on the plurality of failure occurrences; and
modifying, by the one or more processing circuits, the allowable pump pressure decrease threshold based on at least one of the plurality of representative allowable pump pressure decrease thresholds.

9. The method of claim 1, wherein the change in pump speed is an increase in pump speed over the time period.

10. The method of claim 1, wherein the response action comprises providing a notification to a computing system associated with a technician for the printer, the notification regarding servicing the printer, and wherein the notification is provided before a predefined failure condition of the pump is received.

11. A printer system comprising:
a pump; and
at least one processing circuit coupled to the pump, the at least one processing circuit configured to:
determine that the pump is on;
track a speed of the pump while the pump is on;
track a pressure of the pump corresponding to the tracked speed while the pump is on;
provide the tracked speed and the tracked pressure to a remote computing system; and
initiate a diagnostic action based on the tracked speed and the tracked pressure indicating a decrease in pump pressure exceeding an allowable pump pressure decrease threshold for a predefined time period of operation of the pump.

12. The printer system of claim 11, wherein the diagnostic action comprises operating the pump at a predefined speed for a predefined time duration.

13. The printer system of claim 12, wherein during operation of the pump at the predefined speed for the predefined time duration, diagnostic data is wirelessly transmitted to the remote computing system.

14. The printer system of claim 11, wherein the diagnostic action comprises a shutting down of the printer system and transmitting a notification to a computing device associated with the printer system.

15. The printer system of claim 11, wherein the at least one processing circuit is further configured to:
generate a warning notification in response to the tracked speed of the pump exceeding a predefined speed threshold; and
provide the warning notification to the remote computing system.

16. A computing system comprising:
at least one memory device storing instructions therein; and
at least one processor coupled to the at least one memory device, the at least one processor structured to execute the instructions stored in the at least one memory device to perform operations comprising:
receiving operational data for a plurality of networked printers, the operational data comprising speed data and pressure data for a printer component;
determining a threshold associated with the printer component based on the operational data for the plurality of networked printers;
receiving operational data for a specific printer of the plurality of networked printers over a time period;
identifying a change in speed and a corresponding decrease in pressure exceeding the threshold for the time period for a printer component of the specific printer; and
initiating a response action based on the identification of the change in speed and the corresponding decrease in pressure exceeding the threshold for the time period.

17. The system of claim 16, wherein the instructions further cause operations comprising:
parsing a subset of the operational data for the specific printer to identify speed data associated with the printer component having speeds greater than a predefined threshold value; and
depicting the subset of the operational data on a user interface of a computing device.

18. The system of claim 16, wherein the instructions further cause operations comprising:
wirelessly causing the specific printer to perform the response action;
receiving data regarding operation of the specific printer during the caused response action;
determining that operation of the printer component of the specific printer diverges from an expected output; and
providing a notification to at least one of a local computing device at a location of the specific printer or a computing device remote from the location of the specific printer.

19. The system of claim 16, wherein the instructions further cause operations comprising:
receiving a characteristic of the specific printer comprising at least one of an age of the specific printer, an environmental operating condition of the specific printer, or a usage parameter regarding operation of the specific printer; and
modifying the threshold associated with the printer component based on the at least one of the age of the specific printer, the environmental operating condition of the specific printer, or the usage parameter regarding operation of the specific printer.

20. The system of claim 16, wherein the response action comprises at least one of operating the printer component of the specific printer at a predetermined speed for a predetermined duration or as part of a predefined print cycle.
